(19) United States
(12) Patent Application Publication
(10) Pub. No.: US 2015/0217672 A1
(43) Pub. Date: Aug. 6, 2015

(54) SYSTEM, METHOD, AND APPARATUS FOR MANAGING FRACTURING FLUIDS

(71) Applicant: Schlumberger Technology Corporation, Sugar Land, TX (US)

(72) Inventors: Rod Shampine, Houston, TX (US); Timothy M. Lesko, Conway, AR (US); Edward Leugemors, Needville, TX (US); Jeff Sanders, Conway, AR (US)

(21) Appl. No.: 14/421,700

(22) PCT Filed: Aug. 15, 2013
(86) PCT No.: PCT/US2013/055028

§ 371 Date: Feb. 13, 2015

Related U.S. Application Data
(60) Provisional application No. 61/683,521, filed on Aug. 15, 2012.

(51) Int. Cl. B60P 3/22; E21B 43/26

(52) U.S. Cl. CPC B60P 3/225; E21B 43/26; B60P 3/2245

(57) ABSTRACT

A fluid tank sized to be deliverable by a land based transport, and a means for pressurizing the fluid tank. The fluid tank may be used in oilfield operations field generally, but not exclusively. The fluid tank may be useful for fluid management in a hydraulic fracturing environment.

### BACKGROUND

The statements made herein merely provide information related to the present disclosure and may not constitute prior art, and may describe some embodiments illustrating the invention.

The technical field generally, but not exclusively, relates to fluid management in a hydraulic fracturing environment.

Conventionally known hydraulic fracturing treatments, for example in an oil and/or natural gas environment, suffer from a number of drawbacks and present a number of operational challenges. A few of the drawbacks and challenges include: fracturing fluid treatment volumes can be large enough to exceed the standard available transport capacity of a commercial over the road vehicle; fracturing fluids in certain operations must be continuously deliverable to one or more high pressure capable pumps throughout a treatment operation; fracturing treatment operations may be high fluid flow rate operations and/or may continue for long periods of time; a wellbore or multiple wellbores positioned in proximity or sharing the same main bore may require a number of fracturing stages to occur in the same location, extending the required amount of fluid beyond what a single stage treatment might require; fracturing fluids may be specifically formulated for a particular job; fracturing fluids may have a shelf life which precludes re-use of unused fluid at the completion of a job; the fracturing treatment may occur in a remote location increasing transport costs of fluid and disposal or transport of unused fluid; the fracturing treatment may occur in an area lacking disposal facilities for unused fluid; the fracturing treatment may occur in an environmentally sensitive area increasing disposal costs of unused fluid and/or preventing disposal of unused fluid entirely; fracturing fluids may have high particulate loadings subject to flow difficulties and/or settling issues; fracturing fluids may be highly viscous and/or have high static viscosity and/or yield stress; fracturing fluids may have entrained air; fracturing fluids may have various chemical formulations, which may include formulations that react over time in the presence of oxygen, formulations having volatile compounds therein, and/or formulations which render disposal of unused fluids to be expensive, inconvenient, or not possible.

Accordingly, further technological developments are desirable in this area.

### SUMMARY

The summary is provided to introduce a selection of concepts that are further described below in the detailed description. This summary is not intended to identify key or essential features of the claimed subject matter, nor is it intended to be used as an aid in limiting the scope of the claimed subject matter.

Embodiments pertains to systems having a fluid tank sized to be deliverable by a land based transport, and a means for pressurizing the fluid tank. The fluid tank may be used in oilfield operations such a fracturing.

### BRIEF DESCRIPTION OF THE DRAWINGS

FIG. 1 depicts a system for executing hydraulic fracturing operations.

FIG. 2 depicts a system for executing hydraulic fracturing operations with a pair of fracturing pumps.

FIG. 3 depicts a system for executing hydraulic fracturing operations with a pressure equalizing device.

FIG. 4a is an illustration of a cone at the bottom of a tank.

FIG. 4b is a schematic view of a number of vertically displacing output devices.

FIG. 4c is an illustration of a cubic or rectangular device at the bottom of a tank.

FIG. 4d illustrates a pyramidal frustum device at the bottom of a tank.

FIG. 5 exemplifies one grouping of operations and responsibilities of the controller

### DESCRIPTION OF ILLUSTRATIVE EMBODIMENTS

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

For the purposes of promoting an understanding of the principles of the disclosure, reference will now be made to the embodiments illustrated in the drawings and specific language will be used to describe the same. It will nevertheless be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

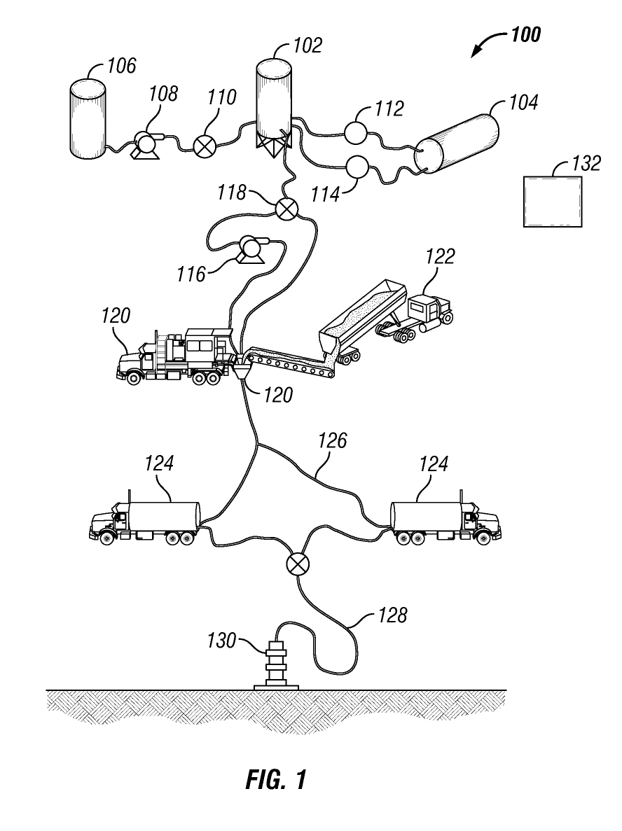

Referencing FIG. 1, a system 100 is depicted for executing hydraulic fracturing operations. The system 100 may be applied to any hydraulic fracturing operation, for example an oilfield operation such as an oil or natural gas operation. Additionally or alternatively, the system 100 may be applicable in certain embodiments to any operations including high fluid volumes, high fluid rates, complex or specialized fluids, and having one or more of the challenges that present in oilfield operations. Example operations may include water injection or production well operations; operations at wells that are deep, high pressure, and/or require high pressure pumping; horizontal, vertical, or deviated wells; locations having multiple wells positioned in close geographic proximity (e.g. on a common pad, kicking off from the same main wellbore); operations where large amounts of fluid and/or specialized fluids must be provided at a location and substantially consumed at the location during the operations; acid fracturing operations; matrix acidizing operations; and/or energized fluid operations. The described applications and operations for the system 100 are non-limiting examples.

The system 100 includes a fracturing fluid tank 102 (and/or a fracturing fluid storage tank 104), where the fracturing fluid tank 102 (and/or a fracturing fluid storage tank 104) is sized to be deliverable by a land based transport. Example land based transports include, without limitation, a tank sized to be positioned to fit on a rail car, a tank sized to be positioned on a truck flat bed, a tank integrated with a truck trailer, and/or a tank integrated with a rail car. The tank may have a size and weight that allow the tank to be delivered to the location of the system 100 in filled or empty condition. The size and weight possibilities for the fracturing fluid tank 102 (and/or a fracturing fluid storage tank 104) may vary according to the available commercial equipment and regulatory environment for example truck weights may be limited to 80,000 lbs. in the U.S., although overweight permits may be available. Regulations differ in other countries. One of skill in the art can readily determine the weight limits and sizes allowable in a given area. Accordingly, although specific examples of fracturing fluid tank 102 embodiments, and fracture fluid storage tank 104 embodiments, are described herein, all examples are non-limiting embodiments.

An example fracturing fluid tank 102 (and/or a fracturing fluid storage tank 104), or alternatively a fracturing fluid storage tank 104, is a “guppy” or “pig”, typically used for hauling sand or dry bulk materials. Bulk materials stored in a PIG often have a specific gravity of about 2, and the PIG has multiple fluid outlets which may be utilized or modified. The typical dimensions of a PIG may be 57 to 54.7 feet long (17.3 m to 16.7 m), about 13.5 feet high (4.1 m) and about 11.6 feet wide (3.5 m); said dimension are not limiting to the present disclosure. A PIG can have a fluid volume exceeding 700 barrels (111 291 L).

Another example fracturing fluid tank 102 (and/or a fracturing fluid storage tank 104) includes a sand hauler. A typical sand hauler may have a capacity of about 185 Barrels (29 412 L) and comprises multiple outlets on the bottom.

Yet another example fracturing fluid tank 102 (and/or a fracturing fluid storage tank 104), may be steel silo tank (such as a Belgrade steel tank silo). Said silo tank is commercially available in various fluid volume configurations, including various fluid volumes between 185 barrels (29412 L) and 1,050 bbl (166 937 L), and a 1,200 bbl (190 785 L) configuration. In the vertical position, the 1,050 BBL silo provides 66 feet of hydraulic head when full, with a final hydraulic head (i.e. just before the vessel is emptied) of 12 feet (20.1 m). In certain embodiments, for example when the silo is pressurized to 14.7 psi (1 atmosphere) and the fluid density in the silo is a specific gravity of 2, it can be seen that the outlet pressure of fluid in the silo, at ground level, is between about 81 psi (558 KPa) when full; and 29 psi (200 KPa) when final/empty. The pressurization target of the vessel can be manipulated to support the delivery pressure as the vessel empties, increasing the 29 psi (200 KPa) final delivery pressure. A tank pressurized to 1 atmosphere at a fluid level of 50 feet (15.2 m) with have a 39 psi (269 KPa) discharge at a specific gravity of 1, and a 65 psi (448 KPa) discharge at a specific gravity of 2. Most fracturing pumps can accommodate input pressure of these values, without the requirement for a fluid delivery pump 116 or blender 120.

The fracturing fluid tank 102 (and/or a fracturing fluid storage tank 104) may be of any size known in the art from any appropriate vessel capable of holding fluids and of being pressurized to the selected pressurization level for the application. Although a number of commercially available vessels are described, in certain embodiments, the fracturing fluid tank 102 (and/or a fracturing fluid storage tank 104) may be a purpose made tank. The vessel pressurization selected for the application depends upon a number of factors that will be known to one of skill in the art contemplating a particular system and having the benefit of the disclosures herein. An example includes a fracturing fluid having a volatile constituent, wherein a lower limit of the vessel pressurization is a vapor pressure of the volatile constituent within the fracturing fluid at the temperature and conditions experienced during operations. Another example includes a fracturing fluid tank 102 (and/or a fracturing fluid storage tank 104) having a high outlet pressure requirement (e.g. feeding fluid directly to the fracturing pumps 124), where little hydraulic head is available (e.g. due to horizontal vessel deployment, inability to raise the vessel, low fluid density within the vessel). One of skill in the art will understand that a larger vessel makes higher pressure more difficult or expensive to achieve, and a smaller vessel makes a higher pressure easier or cheaper to achieve. In certain embodiments, the pressurization is between 0.5 and 1.0 atmospheres of gauge pressure (i.e. above ambient), although embodiments including a range of 1 to 1.8, 0.25 to 0.75, 1 to 1.4, and 0.25 to 3 atmospheres are all contemplated herein. In certain embodiments, the ullage pressure target is selected to provide a fracturing fluid tank 102 outlet pressure, when the fracturing fluid tank 102 is full, of at least: 550 KPa, 515 KPa, 480 KPa, 450 KPa, 410 KPa, 380 KPa, 345 KPa, 310 KPa, 275 KPa, 240 KPa, 205 KPa, or 193 KPa. In certain embodiments, the ullage pressure target is selected to provide the final fracturing fluid 102 outlet pressure, as the fracturing fluid tank 102 approaches empty, of at least: 515 KPa, 480 KPa, 450 KPa, 410 KPa, 380 KPa, 345 KPa 310 KPa, 275 KPa, 240 KPa, 205 KPa, 170 KPa, 138 KPa, 103 KPa, or 69 KPa.

Within a given system, the selected pressurization may vary over time and/or in response to execution related variables. For example, a fracturing fluid warming up over time may lead to a higher vapor pressure and a higher ullage pressure target. An increase in the fracturing fluid density throughout the job, for example due to higher proppant loading stages being provided into the fracturing fluid tank 102 from a fracturing fluid storage tank 104 during operations, may lead to a lower ullage pressure target due to increasing hydraulic head support during the operations. In another example, an increasing flow rate of the fracturing pumps 124 may lead to a higher ullage pressure target during operations. In yet another example, lower fluid levels in the fracturing fluid tank 102 as the operations progress may lead to an increased ullage pressure target.

The described operations are non-limiting examples, and the principles described herein are examples. In certain embodiments, as will be known to one of skill in the art having the benefit of the disclosures herein and contemplating a particular system, the same changes may lead to a different operational result for the ullage pressure. For example, lower fluid levels in the fracturing fluid tank 102 may lead to a lower ullage pressure target, such as when a fluid delivery pump 116 is present, where a bypass valve 118 provides the fluid outlet directly to a blender 120 when the fracturing fluid tank 102 outlet pressure is sufficient, and the bypass valve 118 switches the fluid line to the fluid delivery pump 116 when the fracturing fluid tank 102 outlet pressure falls, allowing for a reduction in the ullage pressure target in certain embodiments.

The system 100 further includes a means for pressurizing the fracturing fluid tank 102. Example and non-limiting pressurizing means include a pump 108 that may provide compressed air or other gases to the fracturing fluid tank 102. The pressurized gases may be pumped directly into the tank ullage (the head space above the liquid in the tank) and/or may be pumped into the fluid and allowed to rise into the tank ullage. Pumping into the fluid at a point below the fluid level increases the workload on the pump, but may provide for mixing, agitation, or other beneficial fluid management operations. Pumping into the ullage above the fluid reduces the pump workload.

Additional or alternative means for pressurizing the fracturing fluid tank 102 include a gas provider 106, which may be a compressed gas reservoir, a separator (e.g. separating N2 real-time from air, or into an intermediate reserve tank not shown during during operations), gas generated from a reactive medium, or other gas source. The gas provider 106 may be coupled to the fracturing fluid tank 102 through a pump 108, and/or directly coupled to the fracturing fluid tank 102 (e.g. when the gas is at a high compression or stored as a liquid with a high vapor pressure) through a valve 110. In the example of FIG. 1, a gas provider 106 is coupled to the pressurizing pump 108, and a three-way valve 110 controls the entry point of the gas into the fracturing fluid tank 102. All described embodiments are non-limiting examples.

In the example of FIG. 1, a fluid delivery pump 116 is coupled to the fracturing fluid tank 102 on an input side. The fracturing fluid tank 102 in FIG. 1 is raised on deployable delivery legs, creating a hydraulic head relative to the fluid delivery pump 116. The raising of the fracturing fluid tank 102 and the presence of a fluid delivery pump 116 are optional, together or individually.

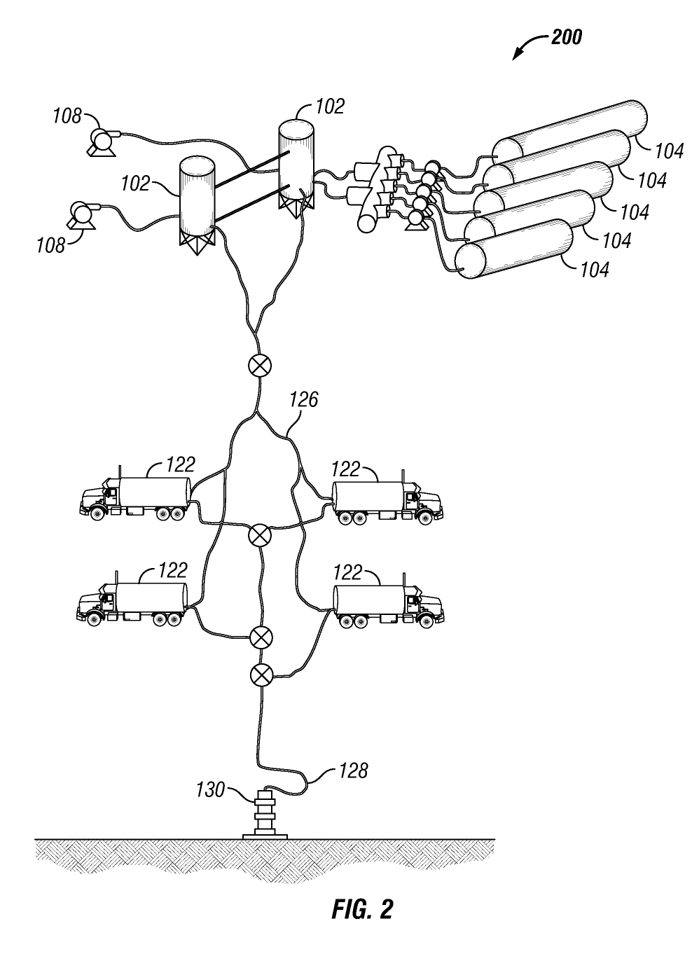

In certain embodiments, the system 100 does not include a pressurizing device between the fracturing fluid tank 102 and a positive displacement pump 124 (e.g. a fracturing pump) which is coupled to a wellbore 130 on a high pressure outlet side, and to the fracturing fluid tank 102 on an inlet side. For example, referencing FIG. 2, a pair of fracturing fluid tanks 102 are directly fluidly coupled to the pumps 124 through low pressure lines 126. Pressuring devices include a fluid delivery pump 116, where present, and a blender 120 (e.g. a POD blender). The blender 120 mixes the fluid from the fracturing fluid tank 102 with proppant as provided by a sand truck 122 in the example.

Where a blender 120 or other device is not present to add proppant, the fluid may be of a type that does not require proppant (e.g. certain types of acid treatments) and/or the proppant may be included within the fluid at the fracturing fluid tank 102. In one example, the fluid is provided to the wellsite fully mixed with proppant added therein, such as in a system described in co-pending co-assigned patent applications with application Ser. No. 13/415,025, filed on Mar. 8, 2012, and application Ser. No. 13/487,002, filed on Jun. 1, 2012, the entire contents of which are incorporated herein by reference in their entireties. The fluid may be staged from various fracturing fluid storage tanks 104 into the fracturing fluid tank 102. The fully mixed fluid with proppant added therein may be a fluid having a very high particle content, including particles having a number of size modalities that inhibit settling of solids within the fluids.

In certain embodiments, the system 100 includes the fracturing fluid tank 102 as a fluid delivery tank, and the system further includes a fluid storage tank 104. The system 100 includes a means for fluid transfer between the fluid storage tank 104 and the fluid delivery tank. The fluid delivery tank, as used herein, is a fluid tank (or tanks) that delivers fluid to downstream devices, including a fluid delivery pump 116, a blender 120, and/or directly to positive displacement pumps 124. The fluid storage tank 104 is fluidly isolated, or isolatable, from the downstream devices. Accordingly, the pressure in the fluid storage tank 104 has more flexibility than to the fluid delivery tank. Additionally or alternatively, fluid storage tanks 104 can be switched out, refilled, added, and/or removed during pumping operations. Multiple fluid tanks 104 can be utilized to change fluids during a treatment, including utilizing portions of each of a number of fluid tanks 104 during a series of sequential fracturing operations. For example and without limitation, each fluid tank 104 may include fracturing fluid having a specified density and proppant loading, and when a fracturing treatment utilizes a fluid having the specified density, the corresponding fluid storage tank 104, or a corresponding mix of a number of fluid storage tanks 104, is utilized to provide fluid.

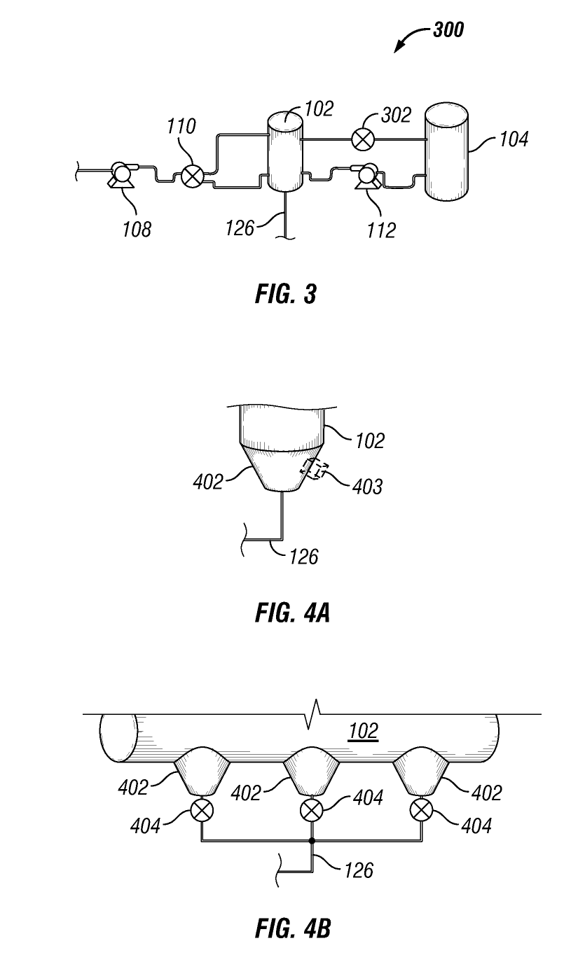

The fluid storage tank 104 may be coupled to a transfer pump 112 that transfers fluid from the fluid storage tank 104 to the fluid delivery tank 102. The transfer pump 112 may be designed to manage the pressure differential required to pump fluid into the fluid delivery tank 102, and/or the fluid storage tank 104 may be pressurized to reduce the work load of the transfer pump 112. The fluid storage tank 104 may be pressurized in a similar manner, and in certain embodiments by the same equipment, utilized to pressure the fluid delivery tank 102. In certain embodiments, for example referencing FIG. 3, a pressure equalizing device 302, such as a valve or controllable valve, fluidly couples a ullage of the fluid delivery tank 102 with the ullage of the fluid storage tank 104, equalizing the ullage pressures in the tanks.

The pump may be of any type that can operate with the pressure differential in the system 100, and/or with the elevated suction pressure from the fluid storage tank 104 that may be present. A double diaphragm pump can operate properly with about 50 psi (345 KPa) on the suction side. A centrifugal pump can manage higher suction pressures with properly designed seals. In certain embodiments, for example a flow through pump such as a centrifugal pump, a valve (not shown) may be positioned in-line with the transfer pump 112 such that the tanks may be fluidly isolated. In certain embodiments, the tanks are not fluidly isolated. The insertion position of the transfer fluid into the fluid delivery tank 102 is selectable. A higher transfer position provides a more consistent delivery pressure requirement, depending upon the ullage pressure in the fluid delivery tank 102. A lower transfer position provides for some mixing and/or agitation to the fluid in the fluid delivery tank 102.

In certain embodiments, the system 100 includes a scavenging pump 114 fluidly coupling the fluid storage tank 104 with the fluid delivery tank 102. The scavenging pump 114 is of a type robust to gas-liquid inlet and may be operated to ensure the fluid storage tank 104 is emptied. In certain embodiments, the fluid transfer pump 114 operates as the scavenging pump 114. In certain embodiments, a scavenging pump 114 is not present. Any gas ingested by the fluid transfer pump 112 and/or scavenging pump 114 that is injected into the fluid delivery tank 102 separates to the ullage of the fluid delivery tank 102 and does not disrupt downstream delivery of liquid.

In certain embodiments, the fluid storage tank 104 is pressurized to a lower pressure than the fluid delivery tank 102. The lower pressure of the fluid storage tank 104, where present, allows for the usage of a larger volume and/or more inexpensively designed fluid storage tank 104 relative to the fluid delivery tank 102. In certain embodiments, the fluid storage tank 104 may be smaller than the fluid delivery tank 102. The fluid storage tank 104 may have separate design criteria, in certain embodiments, from the fluid delivery tank 102 and may be smaller or more expensive than the fluid delivery tank 102. For example, the fluid storage tank 104 may be designed to be more transportable on and off a location during a treatment, and/or designed to quickly couple with fluid transfer pumps and/or pressurizing devices.

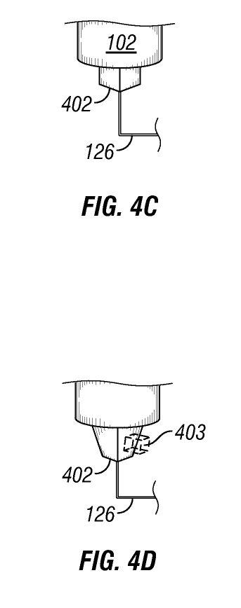

In certain embodiments, the fluid delivery tank 102 includes a vertically displacing output device. A vertically displacing output device includes any device that provides for an incremental increase in vertical fluid level for fluid in the fluid delivery tank 102 at lower fluid levels relative to higher fluid levels. An example includes a portion of the fluid delivery tank 102 having a narrower cross-sectional area than the main tank cross-sectional area. Many dry bulk delivery vessels include a cone-shaped outlet portion. Referencing FIG. 4a, a vertically displacing output device 402 includes a cone at the bottom of the tank 102. The vertically displacing output device 402 includes a discharge sidewall having an angle 403. The angle 403 may be determined in response to the fracturing fluid, for example an angle 403 may be selected to be steeper than a free flow angle of the fracturing fluid. In certain embodiments, the angle 403 is shallower than a dry bulk container discharge sidewall angle for a comparable tank 102, but steeper than a water vessel discharger sidewall angle for a comparable tank 102.

In certain embodiments, the fluid delivery tank 102 does not exist, and the fluid storage tank 104 functions as the fluid delivery tank 102.

Referencing FIG. 4b, a tank 102 includes a number of vertically displacing output devices 402. In certain embodiments, during initial and mid-stage fracturing operations, all of the devices 402 may be open and flowing fluid. As the job nears completion, one or more of the devices 402 may be closed, for example with a valve 404, allowing for the tank 102 to draw further down and scavenge more of the fluid therefrom. In certain embodiments, the tank 102 includes baffles or other separating devices, and/or one or more transfer devices to move fluid from one device 402 to another, for example during a final cleanup operation. The valves 404 are illustrated schematically away from the tank 102 to show the relationships of the valves 404. However, the valves may be integrated with the tank 102, for example as a part of the devices 402 and/or as a part of a fixed discharge line coupled to a vehicle or trailer that carries the tank 102.

Referencing FIG. 4c, a cubic or rectangular device 402 is illustrated. The device of FIG. 4c may be faster or less expensive to manufacture than a curved or conical device 402, and still be sufficient for certain fluids. Referencing FIG. 4d, a pyramidal frustum device 402 is depicted that may be used in certain embodiments. The described shapes for the devices 402 are non-limiting examples.

The example system 100 includes a controller 132 structured to functionally perform certain operations for managing fracturing fluids. In certain embodiments, the controller 132 forms a portion of a processing subsystem including one or more computing devices having memory, processing, and communication hardware. The controller 132 may be a single device or a distributed device, and the functions of the controller may be performed by hardware or software. The controller 132 is in communication with any sensors, actuators, i/o devices, and/or other devices that allow the controller 132 to perform any described operations.

In certain embodiments, the controller 132 includes one or more modules structured to functionally execute the operations of the controller 132. In certain embodiments, the controller 132 includes a system status module and a fluid delivery module. An example system status module interprets an outlet pressure of the fracturing fluid tank 102 and a delivery pressure requirement. An example fluid delivery module determines a target ullage pressure in response to the outlet pressure of the fracturing fluid tank and the delivery pressure requirement. An example pressurizing device 108 is responsive to the target ullage pressure. Example and non-limiting pressurizing devices include a pressurizing pump and a compressed gas valve. In certain embodiments, the controller 132 further includes a pressurization source module, a fluid transfer management module, a tank cleanup module, and/or a fluid agitation module.

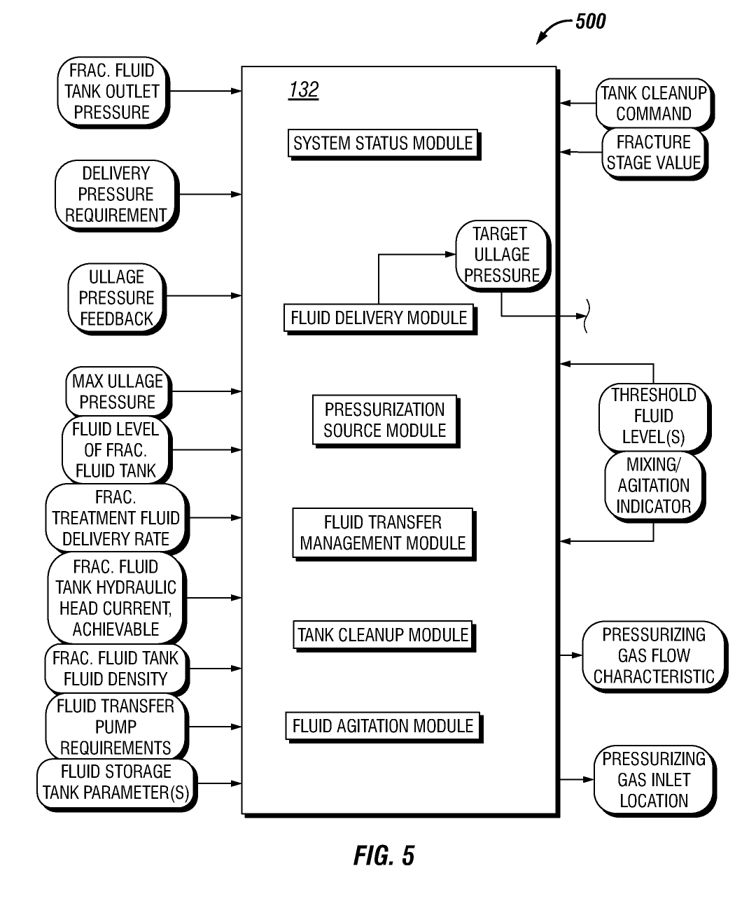

The description herein including modules emphasizes the structural independence of the aspects of the controller 132, and illustrates one grouping of operations and responsibilities of the controller 132. Other groupings that execute similar overall operations are understood within the scope of the present application. Modules may be implemented in hardware and/or software on computer readable medium, and modules may be distributed across various hardware or software components. More specific descriptions of certain embodiments of controller operations are included in the portions of the description referencing FIG. 5.

Certain operations described herein include operations to interpret one or more parameters. Interpreting, as utilized herein, includes receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a computer readable medium, receiving the value as a run-time parameter by any means known in the art including operator entry, and/or by receiving a value by which the interpreted parameter can be calculated, and/or by referencing a default value that is interpreted to be the parameter value.

Referencing FIG. 5, a processing subsystem 500 includes a controller 132 a system status module that interprets an outlet pressure of the fracturing fluid tank, and a delivery pressure requirement. Example operations to interpret the outlet pressure of the fracturing fluid tank include reading a pressure sensor value from a pressure sensor fluidly coupled to the fracturing fluid tank outlet; detecting cavitation in a fluid delivery pump, a blender, or a fracturing pump inlet; interpreting a ullage pressure and calculating the outlet pressure; and/or interpreting a ullage pressure and comparing against a lookup table of ullage pressures that are calibrated to provide a desired outlet pressure.

The desired pressure requirement (or desired delivery pressure) may be a fracturing pump inlet pressure requirement, a fluid delivery pump inlet pressure requirement, a minimum pressure threshold value, and/or a desired delivery pressure value. During a fracturing treatment, the desired pressure requirement may vary. For example, and without limitation, a fluid delivery pump and/or blender may be bypassed during a portion of a treatment, wherein the desired pressure requirement is determined from the first device downstream of the fracturing fluid tank. Additionally or alternatively, a pump may go down during a treatment (e.g. the pump having the highest inlet pressure requirement), a fluid characteristic may change (e.g. viscosity or particulate loading change that may change the inlet pressure requirement), and/or an engineering margin may change during the treatment providing for an increased or decreased pressure margin (e.g. the flush may not be considered a critical stage relative to the pad or a proppant stage).

The controller 132 includes a fluid delivery module that determines a target ullage pressure in response to the outlet pressure of the fracturing fluid tank and the delivery pressure requirement. Example operations to determine the target ullage pressure include calculating a ullage pressure that will correct the outlet pressure to a desired value; utilizing a lookup table of ullage pressures that are calibrated to provide the desired outlet pressure; and/or maintaining a specified minimum ullage pressure, where the specified minimum ullage pressure was determined to provide a minimum outlet pressure value. Where ullage pressure values and/or values for lookup tables are provided, the values may be provided as: a function of fluid density and/or fluid level in the fracturing fluid tank, based upon experience with the fluids, equipment, and/or the treated formations in the system; based upon rules of thumb; and/or be values determined according to estimates such as conservative estimates or “worst-case” estimates (e.g. lower tank levels and/or less dense fracturing fluids). In certain embodiments, the target ullage pressure is further determined in response to a tank pressure limit, a maximum ullage pressure, an operating pressure limit of a pressurizing device 108, and/or a pressure selected to conserve compressed gases sufficiently to complete a fracturing treatment or series of treatments.

In certain embodiments, the system status module further interprets a current ullage pressure value, and the pressurizing device is further responsive to the current ullage pressure value. Accordingly the pressurizing device can control the ullage pressure in a feedback control manner, additionally or alternatively to controlling the fracturing fluid tank outlet pressure.

In certain embodiments, the fluid delivery pump is selectively fluidly interposed between the fracturing fluid tank and a positive displacement pump coupled to the fracturing fluid tank on an intake side, and to a wellbore on an output side. For example in FIG. 1, the system 100 includes a bypass valve that provides fluid directly to the blender 120 or to a fluid delivery pump 116. Additionally or alternatively, a bypass valve (not shown) can provide selective bypass of the blender 120. An example controller 120 further includes a pressurization source module that selects a pressurization source (for the pumps 124). Example selected pressurization sources include the fracturing fluid tank outlet pressure, the fluid delivery pump, and/or the blender.

Example operations by the pressurization source module to select the pressurization source include: determining that maximum ullage pressure limits an outlet pressure of fracturing fluid tank; selecting a source in response to a fluid level of the fracturing fluid tank (e.g. based on a calibrated table); selecting a source in response to a fluid delivery rate of the positive displacement pump(s) (i.e. the treatment pump rate; e.g. based on a calibrated table); selecting a source in response to a fluid delivery rate of the blender; selecting a source in response to a current hydraulic head value of the fracturing fluid tank; selecting a source in response to an achievable hydraulic head value of the fracturing fluid tank (e.g. combined with control operations to return the fracturing fluid tank to the achievable level through tank filling and/or fluid density changes); and/or selecting a source in response to a current fracturing fluid density value of fluid in the fracturing fluid tank.

In certain embodiments, the system includes the fracturing fluid tank being a fluid delivery tank, where the system further includes a fluid storage tank, a means for fluid transfer between the fluid storage tank and the fluid delivery tank, and a means for pressurizing the fluid storage tank. The example controller 132 further includes a fluid transfer management module that controls a ullage pressure of the fluid storage tank in response to a fluid transfer rate of the means for fluid transfer (e.g. a fluid transfer pump rate), that controls a ullage pressure of the fluid storage tank in response to a requirement of a fluid transfer pump (e.g. a minimum or maximum suction pressure), that controls a ullage pressure of the fluid storage tank in response to a current hydraulic head value of the fracturing fluid tank (e.g. to assist in delivery of fluid storage tank fluid into the fluid delivery tank), that controls the ullage pressure of the fluid storage tank in response to a ullage pressure of the fluid delivery tank (e.g. to equalize the ullage pressures, may be performed with a controllable equalization valve 302), that controls the ullage pressure of the fluid storage tank in response to a current hydraulic head value of a second fluid storage tank (e.g. to keep tank outlets equalized, such as in an embodiment like FIG. 2), and/or to control a ullage pressure of the fluid storage tank in response to a ullage pressure of a second fluid storage tank.

In certain embodiments, the system includes a scavenging pump 114 fluidly interposed between the fluid storage tank and the fluid delivery tank. An example controller 132 includes a tank cleanup module that operates the scavenging pump in response to at least one of: a threshold fluid level value in the fluid storage tank; a tank cleanup command value; a fracture stage value; and/or a loss of prime, aeration incident, and/or threshold suction pressure value at a fluid transfer pump. Example operations of the tank cleanup module include determining that a fluid storage tank is almost empty and operating the scavenging pump to clean it out; accepting an input that commands a particular tank to be cleaned up, such as a user entered command, a predetermined operation to clean a specified tank at a specified treatment progression point, a global command to clean all storage tanks (e.g. during the flush), and/or an input that commands a particular tank to be cleaned up in response to a detected event (e.g. minimizing the number of tanks with remaining fluid in response to a detected imminent screen-out event).

In certain embodiments, the system includes the fluid delivery tank, and/or one or more fluid storage tanks, having a number of vertically displacing output devices, and a controllable valve capable to close one or more of the vertically displacing output devices. An example controller 132 further includes a tank cleanup module that operates the controllable valve to close one or more of the vertically displacing output devices. Example operations of the tank cleanup module include: closing one of the vertically displacing output devices in response to a threshold fluid level value in the fluid delivery tank; closing one of the vertically displacing output devices in response to a threshold fluid level value in a fluid storage tank; closing one of the vertically displacing output devices in response to a pumping rate value of a fracturing operation; closing one of the vertically displacing output devices in response to a tank cleanup command value; and/or closing one of the vertically displacing output devices in response to a fracture stage value. In certain embodiments, a fluid tank may include baffles or segmented compartments. In certain additional embodiments, one or more baffles may be moveable and may be operated by the tank cleanup module, for example to isolate a compartment corresponding to a closed vertically displacing output device.

In certain embodiments, a tank further includes a transfer pump or other device for transferring fluid from a closed vertically displacing output device to an open vertically displacing output device. An example tank cleanup module further operates the transfer pump to empty out the vertically displacing output device that is closed, and/or to empty a corresponding compartment of the tank.

In certain embodiments, the system includes the pressurizing device (e.g. pressurizing pump 108) having a variable pressure, volumetric flow rate, and/or inlet location into the fracturing fluid tank. An example controller 132 includes a fluid agitation module that mixes or agitates the fluid in the fracturing fluid tank. Example operations include determining that the fluid is to be mixed or agitated, for example the fluid may be mixed or agitated periodically, continuously, in response to a calculated residence time and settling rate, and/or in response to a mixing or agitation command. Further example operations include the fluid agitation module executing a mixing or agitation operation by performing one or more of the following operations: controlling a pressure of the pressurizing gas (with resulting changes in gas inlet velocity and flow dynamics in the tank); controlling a volumetric flow rate of the pressurizing gas (e.g. reducing pressure so a greater volume flows, pulsing gas to generate higher flow rate with the same total volume injected); and/or controlling an inlet position of the pressurizing gas (e.g. operating a valve 110 or similar device, injecting lower in the fluid and/or at various positions in the fluid to induce mixing).

While the disclosure has provided specific and detailed descriptions to various embodiments, the same is to be considered as illustrative and not restrictive in character. Only certain example embodiments have been shown and described. Those skilled in the art will appreciate that many modifications are possible in the example embodiments without materially departing from the disclosure. Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. In the claims, means-plus-function clauses are intended to cover the structures described herein as performing the recited function and not only structural equivalents, but also equivalent structures. For example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

1. A system comprising a fluid tank, wherein the fluid tank is sized to be deliverable by a land based transport, and a means for pressurizing the fluid tank.

2. The system of claim 1, wherein the land based transport comprises a tank sized to fit on a truck flat bed, a tank integrated with a trailer, a tank sized to fit on a rail car, and/or a tank integrated with a rail car.

3. The system of claim 1, further comprising a fluid delivery pump coupled to the fluid tank on an intake side, wherein the fluid tank is structured to be raised and to create a hydraulic head thereby relative to the fluid delivery pump.

4. The system of claim 1, wherein the fluid tank further comprises a vertically displacing output device.

5. The system of claim 4, wherein the vertically displacing output device comprises one of a cone and a sump.

6. The system of claim 4, wherein the vertically displacing output device comprises a device having a simplified manufacturing shape.

7. The system of claim 3, wherein the land based transport further includes delivery legs and a vertical delivery system.

8. The system of claim 1, wherein the fluid tank comprises a volume selected from the volumes consisting of: greater than 79 m³, greater than 111 m³, greater than 158 m³, between 79 m³ and 318 m³ inclusive, between 111 m³ and 238 m³ inclusive, and between 111 m³ and 175 m³ inclusive.

9. The system of claim 1, wherein the fluid tank is structured to accept a pressurization having a gauge pressure value selected from the gauge pressure values consisting of: between 1 and 1.8 atmospheres inclusive, between 0.5 and 1 atmosphere inclusive, between 0.25 and 0.75 atmospheres inclusive, between 1 and 1.4 atmospheres inclusive, and between 0.25 and 3 atmospheres inclusive.

10. The system of claim 1, wherein the fluid tank is positioned and pressurized to deliver a fluid filled pressure output comprising a pressure selected from the pressures consisting of: at least 550 KPa, 515 KPa, 480 KPa, 450 KPa, 410 KPa, 380 KPa, 345 KPa, 310 KPa, 275 KPa, 240 KPa, 205 KPa, or 193 KPa.

11. The system of claim 1, wherein the fluid tank is positioned and pressurized to deliver a final fluid delivery pressure (e.g. at near empty) comprising a pressure selected from the pressures consisting of: 515 KPa, 480 KPa, 450 KPa, 410 KPa, 380 KPa, 345 KPa 310 KPa, 275 KPa, 240 KPa, 205 KPa, 170 KPa, 138 KPa, 103 KPa, or 69 KPa.

12. The system of claim 1, further comprising a positive displacement pump coupled to the fluid tank on an intake side and to a wellbore on an output side.

13. The system of claim 12, wherein there is no pressurizing device fluidly interposed between the fluid tank and the positive displacement pump.

14. The system of claim 1, wherein the fluid tank is a fluid delivery tank, the system further comprising a fluid storage tank and a means for fluid transfer between the fluid storage tank and the fluid delivery tank.

15. The system of claim 14, further comprising a means for pressurizing the fluid storage tank.

16. The system of claim 15, wherein the fluid storage tank is pressurized to a lower pressure than the fluid delivery tank.

17. The system of claim 14, further comprising a pressure equalization device structured to at least selectively couple a fluid storage tank ullage and a fluid delivery tank ullage.

18. The system of claim 14, further comprising a transfer pump structured to move fluid from the fluid storage tank to the fluid delivery tank.

19. The system of claim 18, wherein the transfer pump comprises one of a double diaphragm pump and a centrifugal pump.

20. The system of claim 18, wherein the transfer pump is structured to manage an aerated fluid inlet.

21. The system of claim 14, further comprising a scavenging pump structured to move fluid from the fluid storage tank to the fluid delivery tank.

22. The system of claim 14, wherein the fluid delivery tank comprises a plurality of vertically displacing output devices, the system further comprising a means for closing at least one of the plurality of vertically displacing output devices.

23. The system of claim 22, further comprising a means for transferring fluid to the one or more remaining open vertically displacing output devices from the plurality of vertically displacing output devices.

24. The system of claim 14, wherein the fluid delivery tank is oriented vertically and wherein the fluid storage tank is oriented horizontally.

25. The system of claim 14, wherein the fluid storage tank comprises a tank selected from the tanks consisting of: a sand can, a sand hauler, and a bulk solids hauler.

26. The system of claim 1, wherein the means for pressurizing the fluid tank further comprises a means for mixing and/or agitating a fluid positioned in the fluid tank.

27. The system of claim 1, wherein the means for pressurizing the fluid tank further comprises a means for positioning a specified gas in a ullage of the fluid tank.

28. The system of claim 27, wherein the specified gas comprises at least one gas selected from the gases consisting of: nitrogen, CO2, an inert gas, a gas having a specified temperature, a gas having a specified humidity, and a gas lacking oxygen.

29. The system of claim 4, wherein the vertically displacing output device comprises a discharge sidewall having an angle configured in response to a free flowing angle of a fluid positioned in the fluid delivery tank.

30. The system of claim 1, further comprising a controller, the controller comprising:
a system status module structured to interpret an outlet pressure of the fluid tank and a delivery pressure requirement;
a fluid delivery module structured to determine a target ullage pressure in response to the outlet pressure of the fluid tank and the delivery pressure requirement; and
wherein the means for pressurizing the fluid tank comprises a pressurizing device (comprising one of a pressurizing pump and a compressed gas valve) responsive to the target ullage pressure.

31. The system of claim 30 wherein the delivery pressure requirement comprises at least one pressure selected from the pressures consisting of: a fracturing pump inlet pressure requirement, a fluid delivery pump inlet pressure requirement, a minimum pressure threshold value, and a desired delivery pressure value.

32. The system of claim 30, wherein the target ullage pressure comprises a constant value.

33. The system of claim 30, wherein the system status module is further structured to interpret a current ullage pressure value, and wherein the pressurizing device is further responsive to the current ullage pressure value.

34. The system of claim 30, further comprising:
a fluid delivery pump selectively fluidly interposed between the fluid tank and a positive displacement pump coupled to the fluid tank on an intake side and to a wellbore on an output side;
the controller further comprising a pressurization source module structured to selected a pressurization source comprising one of the fluid tank outlet pressure and the fluid delivery pump in response to at least one parameter selected from the parameters consisting of:
a maximum ullage pressure;
a fluid level of the fluid tank;
a fluid delivery rate of the positive displacement pump;
a fluid delivery rate of a blender in the system fluidly interposed between the fluid delivery pump and the positive displacement pump;
a current hydraulic head value of the fluid tank;
an achievable hydraulic head value of the fluid tank; and
a current fracturing fluid density value of fluid in the fluid tank.

35. The system of claim 30, wherein the fluid tank is a fracturing fluid delivery tank, the system further comprising a fluid storage tank, a means for fluid transfer between the fluid storage tank and the fluid delivery tank, and a means for pressurizing the fluid storage tank;
the controller further comprising a fluid transfer management module structured to perform at least one of the operations selected from the operations consisting of:
controlling a ullage pressure of the fluid storage tank in response to a fluid transfer rate of the means for fluid transfer;
controlling a ullage pressure of the fluid storage tank in response to a requirement of a fluid transfer pump, the means for fluid transfer comprising the fluid transfer pump;
controlling a ullage pressure of the fluid storage tank in response to a current hydraulic head value of the fracturing fluid tank;
controlling a ullage pressure of the fluid storage tank in response to a ullage pressure of the fluid delivery tank;
controlling a ullage pressure of the fluid storage tank in response to a current hydraulic head value of a second fluid storage tank; and
controlling a ullage pressure of the fluid storage tank in response to a ullage pressure of a second fluid storage tank.

36. The system of claim 35, further comprising a scavenging pump fluidly interposed between the fluid storage tank and the fluid delivery tank;
wherein the controller further comprises a tank cleanup module structured to operate the scavenging pump in response to at least one of:
a threshold fluid level value in the fluid storage tank;
a tank cleanup command value;
a fracture stage value; and
a loss of prime, aeration incident, and/or threshold suction pressure value at a fluid transfer pump, the means for fluid transfer comprising the fluid transfer pump.

37. The system of claim 30, wherein the fluid delivery tank comprises a plurality of vertically displacing output devices and a means for closing at least one of the plurality of vertically displacing output devices;
wherein the controller further comprises a tank cleanup module structured to operate the means for closing the at least one of the plurality of vertically displacing output devices in response to at least one of:
a threshold fluid level value in the fluid delivery tank;
a threshold fluid level value in a fluid storage tank;
a pumping rate value of a fracturing operation;
a tank cleanup command value; and
a fracture stage value.

38. The system of claim 37, further comprising a means for transferring fluid to the one or more remaining open vertically displacing output devices from the plurality of vertically displacing output devices, wherein the tank cleanup module is further structured to operate the means for transferring in response to the operating the means for closing.

39. The system of claim 30, wherein the means for pressurizing the fracturing fluid tank further comprises a means for mixing and/or agitating a fracturing fluid positioned in the fracturing fluid tank;
wherein the controller further comprises a fluid agitation module structured to perform at least one of the operations selected from the operations consisting of:
controlling a pressure and/or a flow rate of pressurizing gas in response to determining whether agitation or mixing is indicated; and
controlling at least one inlet position of the pressurizing gas in response to determining whether agitation or mixing is indicated.
